(19) United States
(12) Patent Application Publication
(10) Pub. No.: US 2016/0189457 A1
(43) Pub. Date: Jun. 30, 2016

(54) CONTROL SYSTEM AND CONTROL METHOD FOR VEHICLE ANTI-THEFT

(71) Applicant: HON HAI PRECISION INDUSTRY CO., LTD., New Taipei (TW)

(72) Inventor: HUNG-CHANG KO, New Taipei (TW)

(21) Appl. No.: 14/713,969

(22) Filed: May 15, 2015

(30) Foreign Application Priority Data
Dec. 31, 2014 (TW) 103146524

(51) Int. Cl. G07C 9/00

(52) U.S. Cl. CPC G07C 9/00309; G07C 9/00007; G07C 2009/00769

(57) ABSTRACT

A control method for anti-theft is provided. The method is applied to a vehicle and a smart key. The control method includes: allocating an antenna matrix dynamically according to time and further calculates a magnetic intensity distribution matrix according to the antenna matrix and magnetic intensity distributions; switching the low-frequency transmitting antennas in sequence at every measurement interval; controlling each switched low-frequency transmitting antenna to transmit a low-frequency signal to the smart key; analyzing magnetic intensity of the low-frequency signal, and transmitting a high-frequency signal containing the magnetic intensity; obtaining the magnetic intensity from the high-frequency signal; comparing the magnetic intensity with the corresponding magnetic intensity distribution; generating a launching signal for launching the vehicle when all the magnetic intensities fall into the corresponding magnetic intensity distributions; and launching the vehicle according to the launching signal.

### FIELD

The subject matter herein generally relates to control systems and control methods for vehicle anti-theft.

### BACKGROUND

PKES (Passive Keyless Entry System) refers to a communication between a vehicle and a smart key via the vehicle transmitting the low-frequency signals and the smart key returning the high-frequency signals after receiving the low frequency signals so as to achieve opening the door of the vehicle. However, PKES is easy to be relay attack.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a control system for vehicle anti-theft.

FIG. 2 is a block diagram of an embodiment of an operating environment of the control system for vehicle anti-theft shown in FIG. 1.

FIGS. 3 and 4 together constitute a flowchart of an embodiment of a control method for vehicle anti-theft.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

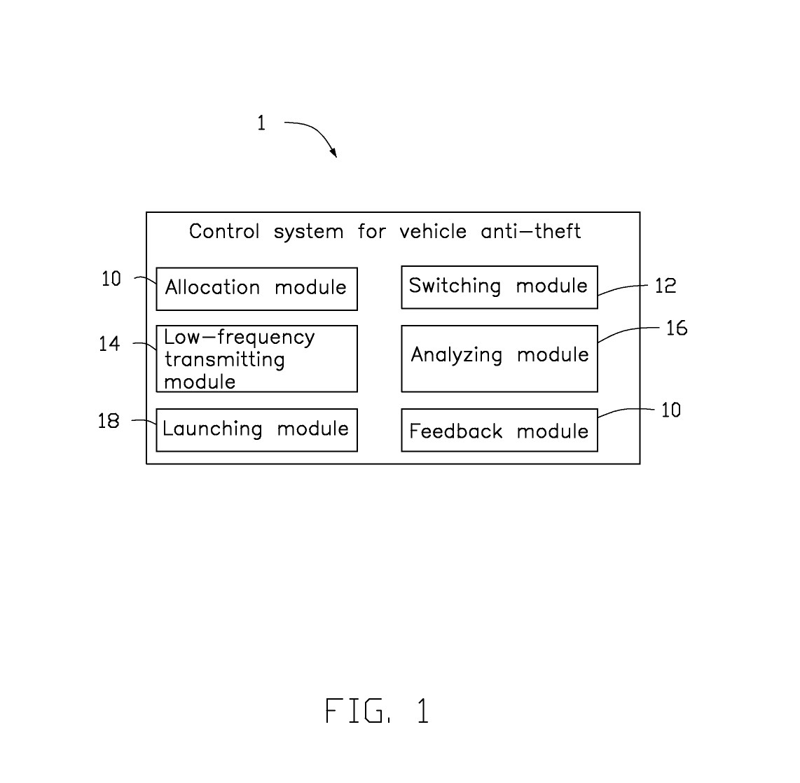

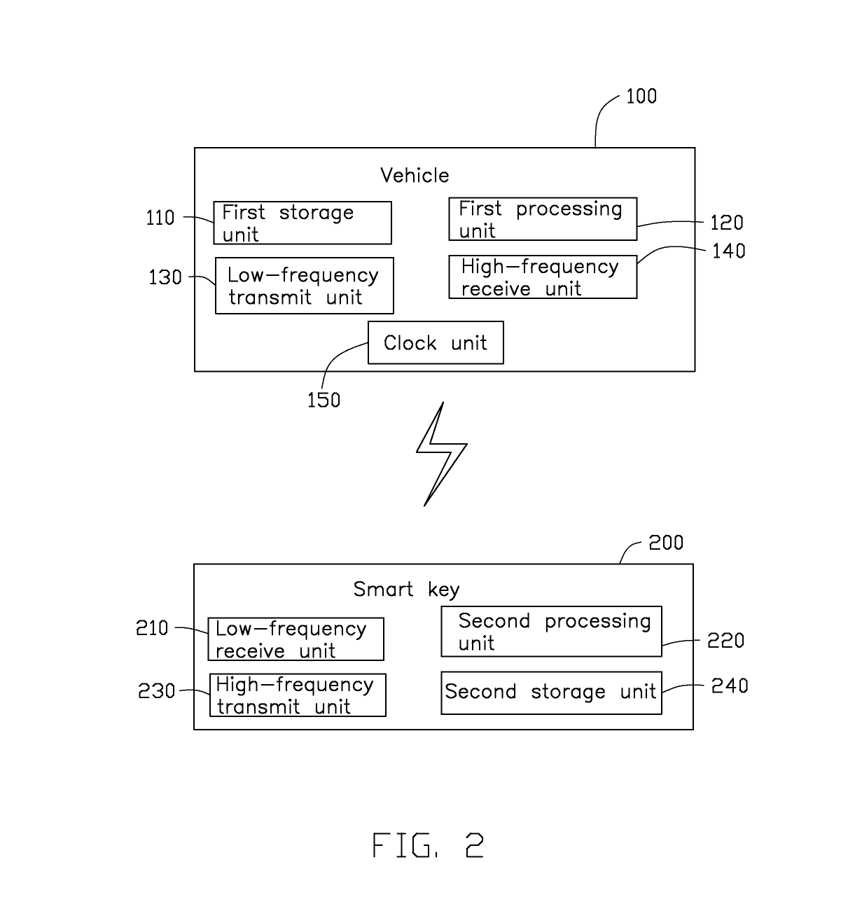

FIG. 1 shows a control system for vehicle anti-theft 1. The control system for vehicle anti-theft 1 can be run on but not limited to a vehicle 100 and a smart key 200 which are shown on FIG. 2.

The vehicle 100 can include a first storage unit 110, a first processing unit 120, a low-frequency transmit unit 130, a high-frequency receive unit 140 and a clock unit 150.

The low-frequency transmit unit 130 can include a number of low-frequency transmitting antennas, and the number of low-frequency transmitting antennas can be named as “L1, L2, L3, L4, L5, L6, L7, L8, . . . , Ln”. The number of low-frequency transmitting antennas can be located on different locations of the vehicle 10. Each low-frequency transmitting antenna can be located on one location of the vehicle 10, such as located on the left side of the driver's seat, the right side of the driver's seat, the front side of the driver's seat, the back side of the driver's seat, the front side of the passenger seat, the back side of the passenger seat, the right side of the passenger seat, the left side of the backseat, the right side of the backseat, the back side of the backseat, or other suitable location of the vehicle 100. Every moment, there is only one low-frequency transmitting antenna which can transmit the low-frequency signal, and the signal strength of the low-frequency signal can be decreased gradually with the distance increasing between the low-frequency signal and the low-frequency transmitting antenna which transmits the low-frequency signal. Furthermore, if the distance between the low-frequency signal and the low-frequency transmitting antenna which transmits the low-frequency signal can be greater than a predefined distance, the signal strength of the low-frequency signal can be attenuated to zero.

The first storage unit 120 can store the locations of the number of the low-frequency transmitting antennas, the magnetic intensity distributions of the low-frequency transmitting antennas relative to the driver's seat, and the antenna identifier of the low-frequency transmitting antennas. The more far between the smart key 200 and the low-frequency transmitting antenna, the less magnetic intensity of the low-frequency signal received by the smart key 200. By contrast, the distance between the smart key 200 and the low-frequency transmitting antenna can be determined according to the magnetic intensity of the received low-frequency signal, and if the magnetic intensity of each the low-frequency signal received by the smart key 200 low-frequency transmitting antennas falls into the magnetic intensity distribution of the low-frequency transmitting antenna, it is indicated that the smart key 200 is on the driver's seat, that is, the user who carries the smart key 200 is on the driver's seat.

The first storage unit 110 can further store a relationship recording the number of antenna matrixes and the time, for example, when it is 12:00 PM, the antenna matrix is A, however, when it is 12:10 PM, the antenna matrix is B.

The smart key 200 can include a second storage unit 210, a second processing unit 220, a low-frequency receive unit 230 and a high-frequency transmit unit 240.

In at least one embodiment, the first storage unit 110 and the second storage unit 210 can be an internal storage system, such as a flash memory, a random access memory (RAM) for temporary storage of information, and/or a read-memory (ROM) for permanent storage of information.

In at least one embodiment, the first storage unit 110 and the second storage unit 210 can also be a storage system, such as a hard disk, a storage card, or a data storage medium. The first storage unit 110 and the second storage unit 210 can include volatile and/or non-volatile storage devices.

In at least one embodiment, the first storage unit 110 and the second storage unit 210 can include two or more storage devices such that one storage device is a memory and the other storage device is a hard drive. Additionally, the first storage unit 110 and the second storage unit 210 can be respectively located either entirely or partially external relative to the vehicle 100 or the smart key 200.

In at least one embodiment, the first processing unit 120 and the second processing unit 220 can be a central processing unit, a digital signal processor, or a single chip, for example.

Referring to FIG. 1, the control system for vehicle anti-theft 1 can include a number of modules, and the number of modules can include an allocation module 10, a switching module 12, a low-frequency transmitting module 14, an analyzing module 16, a launching module 18 and a feedback module 20. The number of modules can be stored in the first storage unit 110 and/or second storage unit 210, and further applied on the first processing unit 120 and/or second processing unit 220. In this embodiment, the allocation module 10, the switching module 12, the low-frequency transmitting module 14, the analyzing module 16 and the launching module 18 can be stored in the first storage unit 110, and applied on the first processing unit 120. The feedback module 20 can be stored in the second storage unit 210, and applied on the second processing unit 220. The details are as follows.

The allocation module 10 can be used to allocate an antenna matrix dynamically according to the time recorded by the clock unit 150 and further calculate a magnetic intensity distribution matrix according to the allocated antenna matrix and the magnetic intensity distributions, and the elements of the antenna matrix and the elements of the magnetic intensity distribution matrix are one to one correspondence. For example, when it is 12:00 PM, the allocation module 10 can be used to allocate an antenna matrix A=[L1 L2 L3 L4 L5 L6 L7 L8 . . . Ln], and the magnetic intensity distribution matrix A1=[X1 X2 X3 X4 X5 X6 X7 X8 . . . Xn], when it is 12:10 PM, the allocation module 10 can be used to allocate another antenna matrix B=[L1 L3 L5 L7 L2 L4 L6 L8 . . . Ln], and the magnetic intensity distribution matrix B1=[X1 X3 X5 X7 X2 X4 X6 X8 . . . Xn], that is, the allocated antenna matrix is changed by the time, and the magnetic intensity distribution matrix is changed by the time accordingly.

The switching module 14 can be used to switch the low-frequency transmitting antennas according to the allocated antenna matrix in sequence at every measurement interval, for example, when it is 12:00 PM, the antenna matrix is A=[L1 L2 L3 L4 L5 L6 L7 L8 . . . Ln], the switching module 14 can be used to switch to a low-frequency transmitting antenna L1 firstly, after a measurement interval, for example, 5 seconds, the switching module 14 can be used to switch to a low-frequency transmitting antenna L2 secondly, after a measurement interval again, for example, 5 seconds, the switching module 14 can be used to switch to a low-frequency transmitting antenna L3 thirdly, and the like, until the switching module 14 can be used to switch to a low-frequency transmitting antenna Ln, the switching module 14 can be used to switch to the low-frequency transmitting antenna L1 again. When it is 12:10 PM, the antenna matrix is B=[L1 L3 L5 L7 L2 L4 L6 L8 . . . Ln], the switching module 14 can be used to switch to the low-frequency transmitting antenna L1 firstly, after a measurement interval, for example, 5 seconds, the switching module 14 can be used to switch to the low-frequency transmitting antenna L3 secondly, after a measurement interval again, for example, 5 seconds, the switching module 14 can be used to switch to the low-frequency transmitting antenna L5 thirdly, and the like, until the switching module 14 can be used to switch to the low-frequency transmitting antenna Ln, the switching module 14 can be used to switch to the low-frequency transmitting antenna L1 again. In at least one embodiment, the measurement interval can be defined according to need.

The low-frequency transmit module 14 can be used to control the switched low-frequency transmitting antenna to transmit a low-frequency signal containing a predefined frequency and an antenna identifier. In at least one embodiment, the low-frequency signal can further contain a communication identifier and time information.

The smart key 200 can receive the number of low-frequency signals transmitted by the number of low-frequency transmitting antennas in sequence. Each time after the smart key 200 receives a low-frequency signal, and the smart key 200 analyzes the magnetic intensity of the low-frequency signal, and further obtains the antenna identifier, the communication identifier and the time information from the low-frequency signal, and further transmits a high-frequency signal containing the magnetic intensity, the communication identifier and the time information. In at least one embodiment, the smart key 200 can further correct its time according to the time information.

The vehicle 100 can receive the number of high-frequency signals transmitted by the smart key 200. Each time after the vehicle 100 receives a high-frequency signal, the vehicle 100 obtains the magnetic intensity, the antenna identifier, the communication identifier and the time information from the high-frequency signal, further reads a magnetic intensity distribution from the corresponding magnetic intensity distribution matrix, and further compares the magnetic intensity with the magnetic intensity distribution, determines whether the magnetic intensity falls into the magnetic intensity distribution. If the magnetic intensity of all the high-frequency signals falls into the corresponding magnetic intensity distributions, it is indicated that the smart key 200 is on the driver's seat, the vehicle 100 are launched. The details are as follows.

When the smart key 200 is within a predefined distance of the vehicle 100, the low-frequency receive unit 230 of the smart key 200 can receive the low-frequency signal. As the magnetic intensity of low-frequency signal can be attenuated with the distance increasing between the smart key 200 and the low-frequency transmit unit 230, so the magnetic intensity of low-frequency signal can be changed according to the change of the distance between the smart key 200 and the low-frequency transmit unit 230.

The feedback module 20 can be used to analyze the magnetic intensity of the low-frequency signal, and further obtain the antenna identifier, the communication identifier and the time information from the low-frequency signal, and further transmit a high-frequency signal containing the magnetic intensity, the communication identifier and the time information.

The high-frequency receive unit 140 of the vehicle 100 can receive the high-frequency signal.

The analyzing module 16 can be used to obtain the magnetic intensity, the antenna identifier, the communication identifier and the time information from the high-frequency signal, further read a magnetic intensity distribution from the corresponding magnetic intensity distribution matrix, and further compare the magnetic intensity with the magnetic intensity distribution, and determine whether the magnetic intensity falls into the magnetic intensity distribution, and further determine whether the low-frequency transmitting antenna is a last low-frequency transmitting antenna of the antenna matrix when determined that the magnetic intensity falls into the magnetic intensity distribution, and determine that the smart key 200 is on the driver's seat and generate a launching signal for launching the vehicle 100 when determined that the low-frequency transmitting antenna is the last low-frequency transmitting antenna of the antenna matrix, and further determine whether the magnetic intensity of a new received low-frequency signal falls into the magnetic intensity distribution when determined that the low-frequency transmitting antenna is not the last low-frequency transmitting antenna of the antenna matrix, and the like, until the analyzing module 16 determines that the low-frequency transmitting antenna is the last low-frequency transmitting antenna of the antenna matrix, the analyzing module 16 generates the launching signal for launching the vehicle 100.

The launching module 18 can be used to launch the vehicle 100 according to the launching signal.

In at least one embodiment, the number of low-frequency transmitting antennas can include one or more virtual antennas. When the switching module 14 switches to a virtual antenna, the virtual antenna cannot transmit a low-frequency signal. The vehicle 100 cannot receive a low-frequency signal, the vehicle 100 cannot thus transmit a high-frequency signal.

When the vehicle 100 determines that the smart key 200 is on the driver's seat according to the magnetic intensity, the vehicle 100 will launch the vehicle 100. However, when the vehicle 100 determines that the smart key 200 is not on the driver's seat according to the magnetic intensity, the vehicle 100 will not launch the vehicle 100. That is to say, if a third party is on the outside of the vehicle 100, the third party cannot launch the vehicle 100 via a smart key. As we known, the third party generally transmits the high-frequency signal with only one magnetic intensity, so the third party cannot launch the vehicle 100. Furthermore, when the switching module 14 switches to a virtual antenna, the virtual antenna cannot transmit a low-frequency signal, however, the third party mistakenly assumes that the vehicle 100 has transmitted a low-frequency signal, so still transmits a high-frequency signal. Of course, the vehicle 100 cannot be launched.

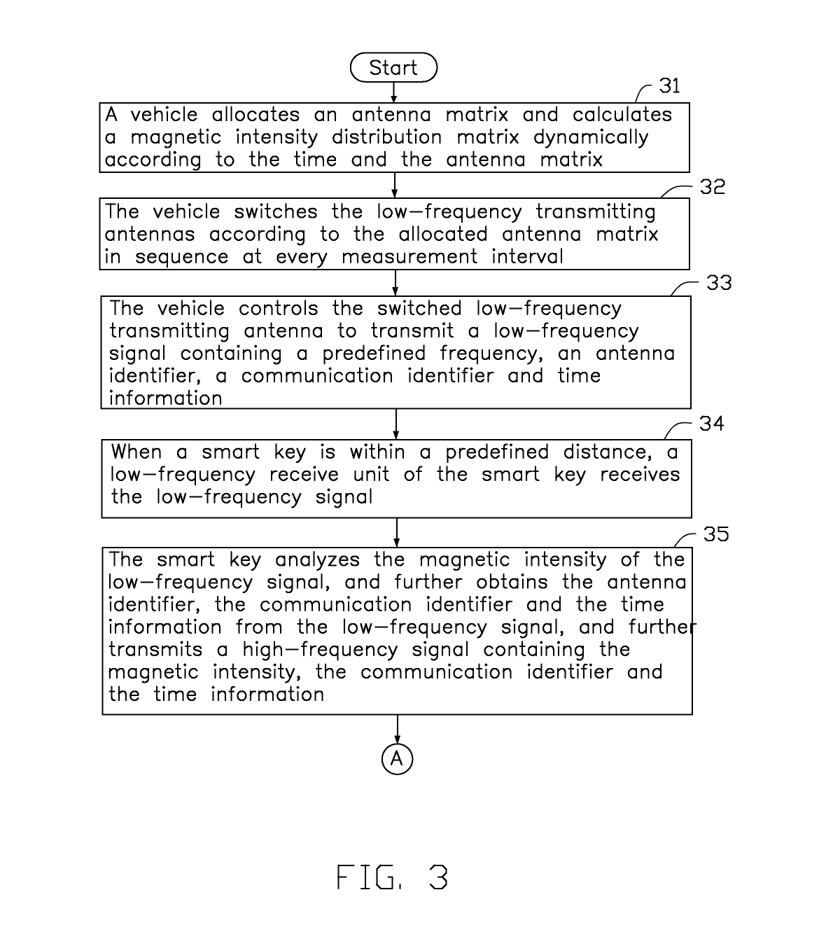

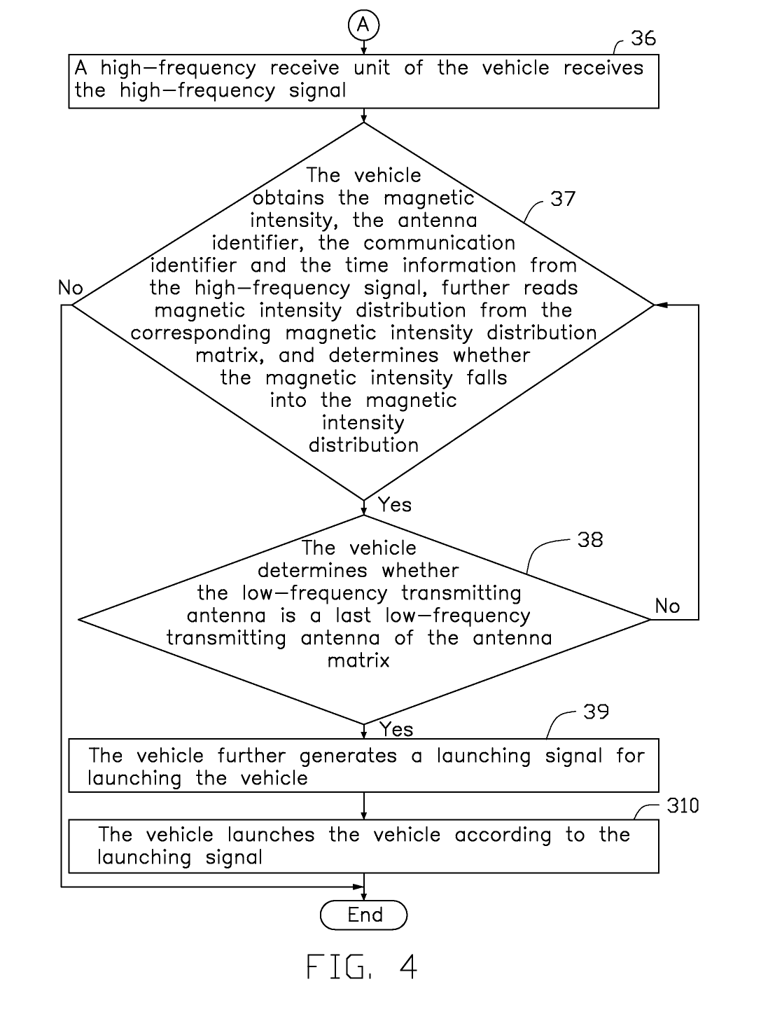

FIGS. 3 and 4 together illustrate a flowchart of a control method for a vehicle anti-theft. The control method is provided by way of example, as there are a variety of ways to carry out the method. The control method described below can be carried out using the configurations illustrated in FIG. 1, for example, and various elements of these figures are referenced in explaining the example method. Each block shown in FIGS. 3 and 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 31.

At block 31, a vehicle allocates an antenna matrix and calculates a magnetic intensity distribution matrix dynamically according to the time and the magnetic intensity distributions. In detail, an allocation module allocates the antenna matrix dynamically according to the time recorded by a clock unit and further calculates the magnetic intensity distribution matrix according to the antenna matrix and the magnetic intensity distributions, and the elements of the antenna matrix and the elements of the magnetic intensity distribution matrix are one to one correspondence.

At block 32, the vehicle switches the low-frequency transmitting antennas according to the allocated antenna matrix in sequence at every measurement interval. In detail, a switching module switches the low-frequency transmitting antennas according to the allocated antenna matrix in sequence at every measurement interval.

At block 33, the vehicle controls the switched low-frequency transmitting antenna to transmit a low-frequency signal containing a predefined frequency, an antenna identifier, a communication identifier and time information. In detail, a low-frequency transmit module controls the switched low-frequency transmitting antenna to transmit the low-frequency signal containing the predefined frequency, the antenna identifier, the communication identifier and the time information.

At block 34, when a smart key is within a predefined distance of the vehicle, a low-frequency receive unit of the smart key receives the low-frequency signal.

At block 35, the smart key analyzes the magnetic intensity of the low-frequency signal, and further obtains the antenna identifier, the communication identifier and the time information from the low-frequency signal, and further transmits a high-frequency signal containing the magnetic intensity, the communication identifier and the time information. In detail, a feedback module analyzes the magnetic intensity of the low-frequency signal, and further obtains the antenna identifier, the communication identifier and the time information from the low-frequency signal, and further transmits the high-frequency signal containing the magnetic intensity, the communication identifier and the time information.

At block 36, a high-frequency receive unit of the vehicle receives the high-frequency signal.

At block 37, the vehicle obtains the magnetic intensity, the antenna identifier, the communication identifier and the time information from the high-frequency signal, further reads a magnetic intensity distribution from the corresponding magnetic intensity distribution matrix, and further compares the magnetic intensity with the magnetic intensity distribution, and determines whether the magnetic intensity falls into the magnetic intensity distribution, if yes, the process goes to block 38, otherwise, the process goes to end. In detail, an analyzing module obtains the magnetic intensity, the antenna identifier, the communication identifier and the time information from the high-frequency signal, further reads the magnetic intensity distribution from the corresponding magnetic intensity distribution matrix, and further compares the magnetic intensity with the magnetic intensity distribution, and determines whether the magnetic intensity falls into the magnetic intensity distribution, if yes, the process goes to block 38, otherwise, the process goes to end.

At block 38, the vehicle determines whether the low-frequency transmitting antenna is a last low-frequency transmitting antenna of the antenna matrix, if yes, the process goes to block 39, otherwise, the process goes to block 36. In detail, the analyzing module further determines whether the low-frequency transmitting antenna is a last low-frequency transmitting antenna of the antenna matrix, if yes, the process goes to block 39, otherwise, the process goes to block 36.

At block 39, the vehicle further generates a launching signal for launching the vehicle. In detail, the analyzing module further generates a launching signal for launching the vehicle.

At block 310, the vehicle launches the vehicle according to the launching signal. In detail, a launching module launches the vehicle according to the launching signal.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A control system for vehicle anti-theft, running on a vehicle and a smart key, the control system comprising:
a plurality of processing units; and
a plurality of modules coupled to the plurality of processing units, each of the plurality of modules including instructions to be executed by one or more of the plurality of processing units, the plurality of modules comprising:
an allocation module configured to, upon execution by the plurality of processing units, cause the plurality of processing units to allocate an antenna matrix dynamically according to time and further calculates a magnetic intensity distribution matrix according to the antenna matrix and magnetic intensity distributions, wherein a relationship recording a plurality of antenna matrixes and the time, and a plurality of magnetic intensity distributions of a plurality of low-frequency transmitting antennas relative to a driver's seat are stored in a first storage unit of the vehicle;
a switching module configured to, upon execution by the plurality of processing units, cause the plurality of processing units to switch the low-frequency transmitting antennas according to the allocated antenna matrix in sequence at every measurement interval;
a low-frequency transmit module configured to, upon execution by the plurality of processing units, cause the plurality of processing units to control each switched low-frequency transmitting antenna to transmit a low-frequency signal, the smart key receiving the low-frequency signal when the smart key is within a predefined distance of the vehicle;
a feedback module configured to configured to, upon execution by the plurality of processing units, cause the plurality of processing units to analyze a magnetic intensity of the low-frequency signal, and transmit a high-frequency signal containing the magnetic intensity;
an analyzing module configured to, upon execution by the plurality of processing units, cause the plurality of processing units to receive the magnetic intensity from the high-frequency signal, read a magnetic intensity distribution from the magnetic intensity distribution matrix corresponding to the each switched low-frequency transmitting antenna, compare the magnetic intensity with the corresponding magnetic intensity distribution, determine whether all the magnetic intensities fall into the corresponding magnetic intensity distributions, and generate a launching signal for launching the vehicle when determined that all the magnetic intensity falls into the corresponding magnetic intensity distribution; and
a launching module configured to, upon execution by the plurality of processing units, cause the plurality of processing units to launch the vehicle according to the launching signal.

2. The control system of claim 1, wherein the analyzing module is further configured to not generate the launching signal when at least one magnetic intensity does not fall into the corresponding magnetic intensity distribution.

3. The control system of claim 1, wherein the analyzing module is further configured to determine whether the low-frequency transmitting antenna is a last low-frequency transmitting antenna of the antenna matrix when one magnetic intensity falls into the corresponding magnetic intensity distribution, and generate the launching signal when the low-frequency transmitting antenna is the last low-frequency transmitting antenna of the antenna matrix.

4. The control system of claim 3, wherein the analyzing module is further configured to determine whether a magnetic intensity of a new received low-frequency signal falls into a corresponding magnetic intensity distribution when the low-frequency transmitting antenna is not the last low-frequency transmitting antenna of the antenna matrix, and generate the launching signal until the analyzing module determines that the low-frequency transmitting antenna is the last low-frequency transmitting antenna of the antenna matrix and the magnetic intensity of the new received low-frequency signal falls into a corresponding magnetic intensity distribution.

5. The control system of claim 1, the allocation module, the switching module, the low-frequency transmitting module, the analyzing module and the launching module are stored and executed in the vehicle.

6. The control system of claim 1, the feedback module is stored and executed in the smart key.

7. A control method for anti-theft, running on a vehicle and a smart key, the control method comprising:
allocating an antenna matrix dynamically according to time and calculating a magnetic intensity distribution matrix according to the antenna matrix and magnetic intensity distributions, wherein a relationship recording a plurality of antenna matrixes and the time, and a plurality of magnetic intensity distributions of a plurality of low-frequency transmitting antennas relative to a driver's seat are stored in a first storage unit of the vehicle;
switching the low-frequency transmitting antennas according to the allocated antenna matrix in sequence at every measurement interval;
controlling each switched low-frequency transmitting antenna to transmit a low-frequency signal, the smart key receiving the low-frequency signal when the smart key is within a predefined distance of the vehicle;
analyzing a magnetic intensity of the low-frequency signal, and transmitting a high-frequency signal containing the magnetic intensity;
receiving the magnetic intensity from the high-frequency signal;
reading a magnetic intensity distribution from the magnetic intensity distribution matrix corresponding to the each switched low-frequency transmitting antenna;
comparing the magnetic intensity with the corresponding magnetic intensity distribution, and determining whether all the magnetic intensities fall into the corresponding magnetic intensity distributions;
generating a launching signal for launching the vehicle when determined that all the magnetic intensities falls into the corresponding magnetic intensity distribution; and
launching the vehicle according to the launching signal.

8. The control method of claim 7, wherein the control method further comprises
not generating the launching signal when at least one magnetic intensity does not fall into the corresponding magnetic intensity distribution; and
not launching the vehicle when there is no launching signal received.

9. The control method of claim 7, wherein the control method further comprises
determining whether the low-frequency transmitting antenna is a last low-frequency transmitting antenna of the antenna matrix when one magnetic intensity falls into the corresponding magnetic intensity distribution;
generating the launching signal when the low-frequency transmitting antenna is the last low-frequency transmitting antenna of the antenna matrix; and
launching the vehicle according to the launching signal.

10. The control method of claim 9, wherein the control method further comprises
determining whether a magnetic intensity of a new received low-frequency signal falls into a corresponding magnetic intensity distribution when the low-frequency transmitting antenna is not the last low-frequency transmitting antenna of the antenna matrix, and the like;
generating the launching signal until the low-frequency transmitting antenna is the last low-frequency transmitting antenna of the antenna matrix and the magnetic intensity of the new received low-frequency signal falls into a corresponding magnetic intensity distribution; and
launching the vehicle according to the launching signal.
